(19) United States
(12) Patent Application Publication
(10) Pub. No.: US 2023/0223619 A1
(43) Pub. Date: Jul. 13, 2023

(54) ENERGY STORAGE DEVICE AND TEMPERATURE CONTROL METHOD THEREOF

(71) Applicant: Merry Electronics(Shenzhen) Co., Ltd., ShenZhen (CN)

(72) Inventors: Yung-Hsiang Liu, Taichung (TW); Wei-Kang Liang, Taichung (TW); Yu-Kai Wang, Taichung (TW)

(73) Assignee: Merry Electronics(Shenzhen) Co., Ltd., ShenZhen (CN)

(21) Appl. No.: 17/705,396

(22) Filed: Mar. 28, 2022

(30) Foreign Application Priority Data
Jan. 12, 2022 (TW) 111101258

(51) Int. Cl. H01M 10/6571; H02M 3/335; H02M 7/219; H02J 7/00; H01M 10/615; H01M 10/63; H01M 10/48

(52) U.S. Cl. CPC H01M 10/6571; H02M 3/33576; H02M 7/219; H02M 3/33573; H02J 7/007194; H01M 10/615; H01M 10/63; H01M 10/486

(57) ABSTRACT

An energy storage device and a temperature control method thereof are provided. When a temperature of a battery is lower than a preset temperature and an alternating current-direct current conversion circuit receives an alternating current input voltage, an inductance-capacitance resonance circuit and a direct current-direct current conversion circuit are controlled to use electrical energy provided by the alternating current-direct current conversion circuit to generate a resonant current to heat the battery. When the temperature of the battery is lower than the preset temperature and the alternating current-direct current conversion circuit does not receive the alternating current input voltage, the inductance-capacitance resonance circuit and the direct current-direct current conversion circuit are controlled to use electrical energy provided by the battery to generate a resonant current to heat the battery.

### CROSS-REFERENCE TO RELATED APPLICATION

This application claims the priority benefit of Taiwan application serial no. 111101258, filed on Jan. 12, 2022. The entirety of the above-mentioned patent application is hereby incorporated by reference herein and made a part of this specification.

### BACKGROUND

### Technical Field

The disclosure relates to a power supply device, and in particular, relates to an energy storage device and a temperature control method thereof.

### Description of Related Art

Generally speaking, the characteristics of a battery are significantly affected by the ambient temperature, especially in a low temperature environment, the available energy and power of the battery is severely attenuated, and the long-term use in the low temperature environment accelerates the aging of the power battery and shortens the service life thereof. The capacity and operating voltage of the battery reduces significantly at the low temperature, and the performance worsens at −20° C., for example, the available discharge capacity drops sharply. In a low temperature environment, it is easy to accumulate and form metallic lithium on a negative electrode surface of the battery, which may pierce the battery diaphragm and create a short circuit inside the battery, which not only causes permanent damage to the battery, but also induces thermal runaway of the battery, such that the safety of using the battery is greatly reduced.

### SUMMARY

The disclosure provides an energy storage device and a temperature control method thereof, which may effectively control the temperature of the battery and improve the service life and safety of using the battery.

The energy storage device of the disclosure includes an alternating current-direct current conversion circuit, a direct current-direct current conversion circuit, a battery, an inductance-capacitance resonance circuit, and a control circuit. The alternating current-direct current conversion circuit is configured to convert an alternating current input voltage received from an alternating current power source into a first direct current voltage. The direct current-direct current conversion circuit is coupled to the alternating current-direct current conversion circuit, and converts the first direct current voltage into a second direct current voltage. The inductance-capacitance resonance circuit is coupled to the direct current-direct current conversion circuit and the battery. The control circuit is coupled to the alternating current-direct current conversion circuit, the direct current-direct current conversion circuit, the battery, and the inductance-capacitance resonance circuit. When a temperature of the battery is lower than a preset temperature and the alternating current-direct current conversion circuit receives the alternating current input voltage, the inductance-capacitance resonance circuit and the direct current-direct current conversion circuit are controlled to use an electrical energy provided by the alternating current-direct current conversion circuit to generate a resonant current to heat the battery, when the temperature of the battery is lower than the preset temperature and the alternating current-direct current conversion circuit does not receive the alternating current input voltage, the inductance-capacitance resonance circuit and the direct current-direct current conversion circuit are controlled to use an electrical energy provided by the battery to generate the resonant current to heat the battery.

In an embodiment of the disclosure, the inductance-capacitance resonance circuit includes a first inductor, a first switch circuit, and a first capacitor. A first terminal and a second terminal of the first inductor are respectively coupled to a positive electrode of the battery and the direct current-direct current conversion circuit. The first switch circuit is coupled to the second terminal of the first inductor. A first terminal and a second terminal of the first capacitor are respectively coupled to the first switch circuit and a negative electrode of the battery, when the temperature of the battery is lower than the preset temperature, the control circuit turns on the first switch circuit, so that the first inductor provides the resonant current, the first inductor stores the electrical energy provided by the alternating current-direct current conversion circuit or the battery.

In an embodiment of the disclosure, the direct current-direct current conversion circuit includes a transformer and a second switch circuit to a ninth switch circuit. The transformer has a first side coil and a second side coil. The third switch circuit and the second switch circuit are connected in series between the second terminal of the first inductor and the second terminal of the first capacitor. The fifth switch circuit and the fourth switch circuit are connected in series between the second terminal of the first inductor and the second terminal of the first capacitor, a common contact of the second switch circuit and the third switch circuit is coupled to a first terminal of the first side coil, and a common contact of the fourth switch circuit and the fifth switch circuit is coupled to a second terminal of the first side coil. The seventh switch circuit and the sixth switch circuit are connected in series between a first direct current output terminal and a second direct current output terminal of the alternating current-direct current conversion circuit. The ninth switch circuit and the eighth switch circuit are connected in series between the first direct current output terminal and the second direct current output terminal of the alternating current-direct current conversion circuit, a common contact of the sixth switch circuit and the seventh switch circuit is coupled to a first terminal of the second side coil, and a common contact of the eighth switch circuit and the ninth switch circuit is coupled to a second terminal of the second side coil.

In an embodiment of the disclosure, when the temperature of the battery is lower than the preset temperature and the alternating current-direct current conversion circuit receives the alternating current input voltage, the second switch circuit to the fifth switch circuit are in an off state. The first switch circuit switches a conducting state thereof at a preset switching frequency. When the first switch circuit is turned on, the sixth switch circuit to the ninth switch circuit are in the off state, and the sixth switch circuit, the ninth switch circuit, and the seventh switch circuit, the eighth switch circuit are complementarily turned on and off, to generate the resonant current to heat the battery.

In an embodiment of the disclosure, the preset switching frequency is equal to a resonance frequency of the inductance-capacitance resonance circuit.

In an embodiment of the disclosure, a magnitude of the resonant current is related to a duty ratio of a conduction control signal of each of the sixth switch circuit to the ninth switch circuit.

In an embodiment of the disclosure, when the temperature of the battery is lower than the preset temperature and the alternating current-direct current conversion circuit does not receive the alternating current input voltage, the sixth switch circuit to the ninth switch circuit are in an off state. The first switch circuit switches a conducting state thereof at a preset switching frequency. When the first switch circuit is turned on, the second switch circuit to the fifth switch circuit are in the off state, and the second switch circuit, the third switch circuit, and the fourth switch circuit, the fifth switch circuit are complementarily turned on and off, to generate the resonant current to heat the battery.

In an embodiment of the disclosure, the preset switching frequency is equal to a resonance frequency of the inductance-capacitance resonance circuit.

In an embodiment of the disclosure, a magnitude of the resonant current is related to a duty ratio of a conduction control signal of each of the second switch circuit to the fifth switch circuit.

The disclosure also provides a temperature control method for an energy storage device. The energy storage device includes an alternating current-direct current conversion circuit, a direct current-direct current conversion circuit, a battery, and an inductance-capacitance resonance circuit. The direct current-direct current conversion circuit is coupled to the alternating current-direct current conversion circuit and the inductance-capacitance resonance circuit. The inductance-capacitance resonance circuit is also coupled to the battery. The alternating current-direct current conversion circuit is configured to convert an alternating current input voltage received from an alternating current power source into a first direct current voltage, the direct current-direct current conversion circuit converts the first direct current voltage into a second direct current voltage, and a power supplying method of the energy storage device includes the following steps.

Whether a temperature of the battery is lower than a preset temperature is determined. Whether the alternating current-direct current conversion circuit receives the alternating current input voltage is determined. If the temperature of the battery is lower than the preset temperature, and the alternating current-direct current conversion circuit receives the alternating current input voltage, the inductance-capacitance resonance circuit and the direct current-direct current conversion circuit are controlled to use an electrical energy provided by the alternating current-direct current conversion circuit to generate a resonant current to heat the battery. If the temperature of the battery is lower than the preset temperature, and the alternating current-direct current conversion circuit does not receive the alternating current input voltage, the inductance-capacitance resonance circuit and the direct current-direct current conversion circuit are controlled to use an electrical energy provided by the battery to generate the resonant current to heat the battery.

Based on the above, the embodiments of the disclosure control the inductance-capacitance resonance circuit and the direct current-direct current conversion circuit to use the electrical energy provided by the alternating current-direct current conversion circuit or the battery to generate a resonant current to heat the battery, so that the battery may be kept at an appropriate temperature and avoid battery damage from the low temperature environment, which may improve the service life and safety of using the battery.

In order to make the aforementioned features and advantages of the disclosure comprehensible, embodiments accompanied with drawings are described in detail below.

### BRIEF DESCRIPTION OF THE DRAWING

FIG. 1 is a schematic diagram of an energy storage device according to an embodiment of the disclosure.

FIG. 2 is a schematic diagram of an energy storage device according to another embodiment of the disclosure.

FIG. 3 is a schematic diagram of a signal timing sequence of an energy storage device according to an embodiment of the disclosure.

FIG. 4 is a schematic diagram of a signal timing sequence of an energy storage device according to another embodiment of the disclosure.

FIG. 5 is a flowchart of a temperature control method of an energy storage device according to an embodiment of the disclosure.

### DETAILED DESCRIPTION OF DISCLOSED EMBODIMENTS

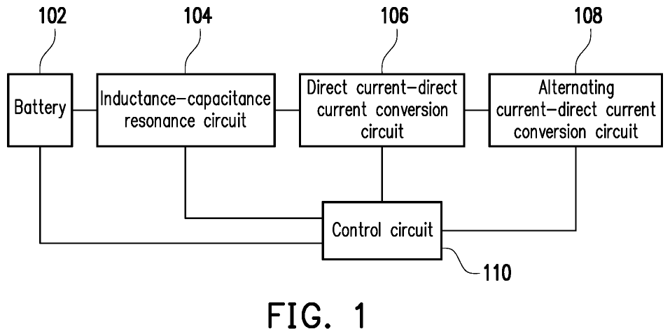

FIG. 1 is a schematic diagram of an energy storage device according to an embodiment of the disclosure. Referring to FIG. 1, the energy storage device may include a battery 102, an inductance-capacitance resonance circuit 104, a direct current-direct current conversion circuit 106, an alternating current-direct current conversion circuit 108, and a control circuit 110. The inductance-capacitance resonance circuit 104 is coupled to the battery 102 and the direct current-direct current conversion circuit 106, the direct current-direct current conversion circuit 106 is coupled to the alternating current-direct current conversion circuit 108, and the control circuit 110 is coupled to the battery 102, the inductance-capacitance resonance circuit 104, the direct current-direct current conversion circuit 106, and the alternating current-direct current conversion circuit 108. The alternating current-direct current conversion circuit 108 may convert the alternating current input voltage received from an alternating current power source (not shown) into a first direct current voltage, and the direct current-direct current conversion circuit 106 may convert the first direct current voltage provided by the alternating current-direct current conversion circuit 108 into a second direct current voltage. The inductance-capacitance resonance circuit 104 may be configured to provide a resonant current to heat the battery 102 so as to keep the battery 102 at a proper temperature.

Further, when the temperature of the battery 102 is lower than the preset temperature, and the alternating current-direct current conversion circuit 108 receives the alternating current input voltage provided by the alternating current power source, the control circuit 110 may control the inductance-capacitance resonance circuit 104 and the direct current-direct current conversion circuit 106 to use the electrical energy provided by the alternating current-direct current conversion circuit 108 to generate a resonant current to heat the battery 102. When the temperature of the battery 102 is lower than the preset temperature, and the alternating current-direct current conversion circuit 108 does not receive the alternating current input voltage, the control circuit 110 may control the inductance-capacitance resonance circuit 104 and the direct current-direct current conversion circuit 106 to use the electrical energy provided by the battery 102 to generate a resonant current to heat the battery 102. The temperature of the battery 102 may be detected by, for example, the control circuit 110, or be detected by a temperature sensor other than the control circuit 110, and subsequently the sensing result is provided to the control circuit 110. In addition, the control circuit 110 may, for example, according to the first direct current voltage output by the alternating current-direct current conversion circuit 108, determine whether the alternating current power source is coupled to the alternating current-direct current conversion circuit 108, or whether the alternating current power source provides an alternating current input voltage.

In this way, the resonant current generated by the electrical energy provided by the alternating current-direct current conversion circuit 108 or the battery 102 is configured to heat the battery 102, so that the battery 102 may be kept at an appropriate temperature, so as to avoid battery damage from the low temperature environment, which may improve the service life and safety of using the battery 102. It is not needed to use two sets of battery packs to charge and discharge each other to heat the battery as in conventional arts, that is, no additional battery is needed to heat the battery, and thus additional cost may be avoided. In addition, when the alternating current-direct current conversion circuit 108 may receive the alternating current input voltage provided by the alternating current power source, it is ensured that the battery 102 may be heated to an appropriate temperature even if the power of the battery 102 is insufficient.

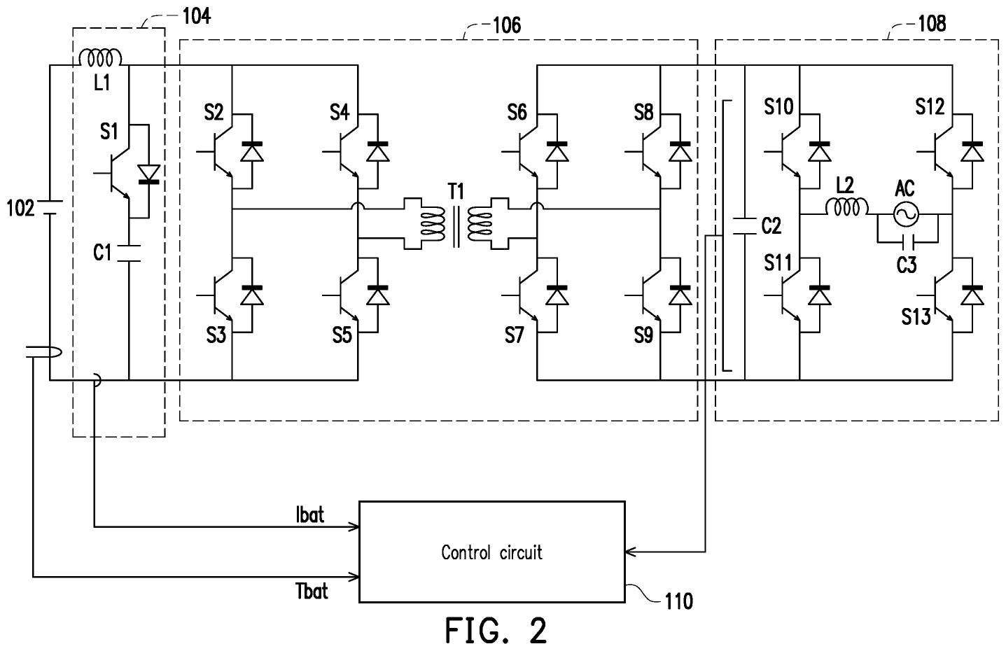

FIG. 2 is a schematic diagram of an energy storage device according to another embodiment of the disclosure. In detail, the energy storage device in the embodiment of FIG. 1 may be implemented by, for example, the circuit with the bidirectional inverter architecture as shown in the embodiment of FIG. 2. In the embodiment of FIG. 2, the inductance-capacitance resonance circuit 104 may include a switch circuit S1, an inductor L1 and a capacitor C1, the direct current-direct current conversion circuit 106 may include switch circuits S2-S9 and a transformer T1, and the alternating current-direct current conversion circuit 108 may include switch circuits S10-S13, an inductor L2, capacitors C2, C3 and an alternating current power source AC. In this embodiment, each of the switch circuits S1-S13 is implemented by a transistor, but is not limited thereto. As shown in FIG. 2, there are parasitic diodes between the collector and the emitter of each of the transistors.

In the inductance-capacitance resonance circuit 104, a first terminal and a second terminal of the inductor L1 are respectively coupled to the positive electrode of the battery 102 and the direct current-direct current conversion circuit 106, the switch circuit S1 is coupled between a second terminal of the inductor L1 and the first terminal of the capacitor C1, and the second terminal of the capacitor C1 is coupled to the negative electrode of the battery 102.

In the direct current-direct current conversion circuit 106, the switch circuit S2 and the switch circuit S3 are connected in series between the second terminal of the inductor L1 and the second terminal of the capacitor C1, the common contact of the switch circuit S2 and the switch circuit S3 is coupled to the first terminal of the first side coil of the transformer T1. The switch circuit S4 and the switch circuit S5 are connected in series between the second terminal of the inductor L1 and the second terminal of the capacitor C1, the common contact of the switch circuit S4 and the switch circuit S5 is coupled to the second terminal of the first side coil of the transformer T1. In addition, the switch circuit S6 and the switch circuit S7 are connected in series between the first direct current output terminal and the second direct current output terminal of the alternating current-direct current conversion circuit 108 (that is, the first terminal and the second terminal of the capacitor C2). The common contact of the switch circuit S6 and the switch circuit S7 is coupled to the first terminal of the second side coil of the transformer T1. The switch circuit S8 and the switch circuit S9 are connected in series between the first direct current output terminal and the second direct current output terminal of the alternating current-direct current conversion circuit 108. The common contact of the switch circuit S8 and the switch circuit S9 is coupled to the second terminal of the second side coil of the transformer T1.

In the alternating current-direct current conversion circuit 108, the switch circuit S10 and the switch circuit S11 are connected in series between the first terminal and the second terminal of the capacitor C2, the switch circuit S12 and the switch circuit S13 are connected in series between the first terminal and the second terminal of the capacitor C2. The inductor L2 and the capacitor C3 are connected in series between the common contact of the switch circuit S10 and the switch circuit S11 and the common contact of the switch circuit S12 and the switch circuit S13, and the capacitor C3 may be coupled to the alternating current power source AC in parallel. In addition, the control circuit 110 is coupled to the control terminals of each of the switch circuits S1-S13 to control the conducting state of the switch circuits S1-S13, for example, a pulse width modulation signal may be output to control the conducting state of the switch circuits S1-S13.

When the control circuit 110 senses that a temperature Tbat of the battery 102 is lower than the preset temperature and the alternating current power source AC is coupled to the alternating current-direct current conversion circuit 108 to provide the alternating current input voltage to the alternating current-direct current conversion circuit 108, the control circuit 110 may control the conducting state of the switch circuits S10-S13, so that the alternating current-direct current conversion circuit 108 generates a first direct current voltage on the capacitor C2. The control circuit 110 may also control the conducting state of the switch circuits S1-S9, so that the inductor L1 stores and releases electrical energy, thereby providing a resonant current to heat the battery 102.

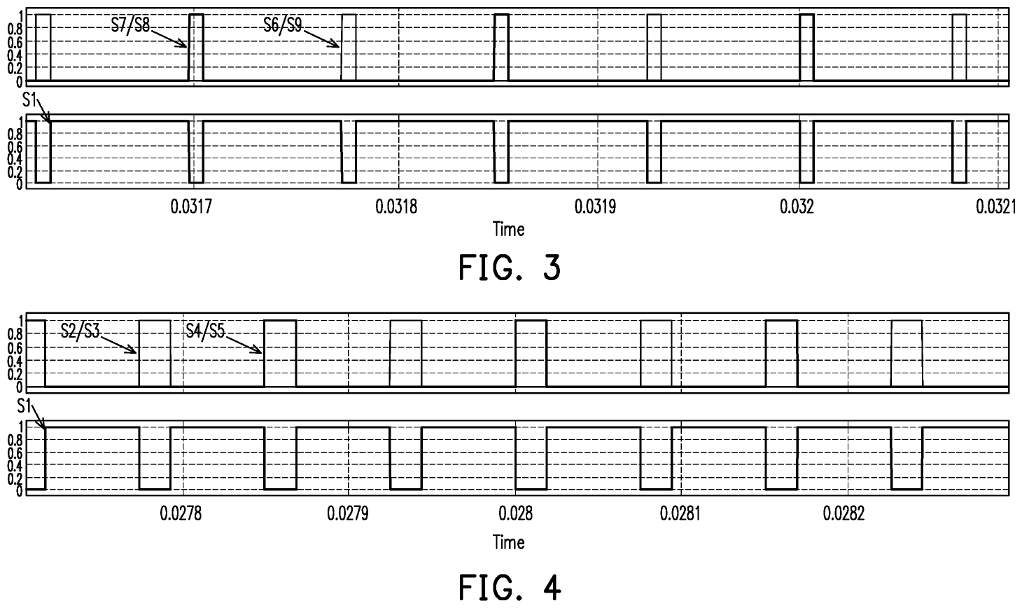

Specifically, when the control circuit 110 senses that the temperature Tbat of the battery 102 is lower than the preset temperature and the alternating current power source AC provides the alternating current input voltage to the alternating current-direct current conversion circuit 108, the control circuit 110 controls the switch circuits S1-S9 in a manner as shown in FIG. 3. The switch circuits S7, S8 and the switch circuits S6, S9 are alternately turned on (the conduction control signals of the control terminals of the switch circuits S7, S8 and the switch circuits S6, S9 are alternately changed from a low voltage level to a high voltage level), that is to say, when the switch circuits S7 and S8 are turned on, the switch circuits S6 and S9 are turned off, and when the switch circuits S6 and S9 are turned on, the switch circuits S7 and S8 are turned off. In addition, when the switch circuits S6, S9 or the switch circuits S7, S8 are turned on, the switch circuit S1 is in an off state (the conduction control signal of the control terminal of the switch circuit S1 is at a low voltage level, the inductor L1 receives the second direct current voltage provided by the direct current-direct current conversion circuit 106 at this time to store the electrical energy from the alternating current-direct current conversion circuit 108), and when the switch circuits S6 and S9 and the switch circuits S7 and S8 are turned off, the switch circuit S1 is in an on state (the conduction control signal of the control terminal of the switch circuit S1 is at a high voltage level, the switch circuit S1 releases the electrical energy stored in the inductor L1 at this time to generate a resonant current). The preset switching frequency of the switch circuit S1 may be, for example, the resonance frequency of the inductance-capacitance resonance circuit 104, but is not limited thereto. In addition, the switch circuits S2-S5 are kept in the off state.

By switching the conducting state of the switch circuits S1-S9 in this way, the inductance-capacitance resonance circuit 104 may generate a resonant current to heat the battery 102. Since the reactive power formed by the resonant current does not actually charge and discharge the battery, the problem of shortening or damaging the battery life of battery due to charging the battery 102 at a low temperature does not occur. Since the current on the inductor L1 is proportional to the voltage across the inductor L1 and the time, the magnitude of the resonant current may be determined by controlling the conducting time of the switch circuits S6-S9 (that is, controlling the duty ratio of the conducting control signals of the switch circuits S6-S9), thereby determining the heating efficiency of the battery 102. Whether the inductor L1 has stored enough electrical energy may be determined by detecting the current Ibat flowing through the battery 102.

In addition, when the control circuit 110 senses that the temperature Tbat of the battery 102 is lower than the preset temperature and the alternating current power source AC is not coupled to the alternating current-direct current conversion circuit 108 or the alternating current power source AC may not provide the alternating current input voltage to the alternating current-direct current conversion circuit 108, the control circuit 110 may also control the conducting states of the switch circuits S1-S13, so that the inductor L1 stores and discharges the electrical energy provided by the battery 102, thereby providing a resonant current to heat the battery 102.

Specifically, when the control circuit 110 senses that the temperature Tbat of the battery 102 is lower than the preset temperature and the alternating current power source AC is not coupled to the alternating current-direct current conversion circuit 108 or the alternating current power source AC does not provide the alternating current input voltage to the alternating current-direct current conversion circuit 108, the control circuit 110 controls the switch circuits S1-S5 in a manner as shown in FIG. 4. The switch circuits S2, S3 and the switch circuits S4, S5 are alternately turned on (the conduction control signals of the control terminals of the switch circuits S2, S3 and the switch circuits S4, S5 are alternately changed from a low voltage level to a high voltage level), that is to say, when the switch circuits S2 and S3 are turned on, the switch circuits S4 and S5 are turned off, and when the switch circuits S4 and S5 are turned on, the switch circuits S2 and S3 are turned off. In addition, when the switch circuits S2, S3 or the switch circuits S4, S5 are turned on, the switch circuit S1 is in an off state (the conduction control signal of the control terminal of the switch circuit S1 is at a low voltage level, and the inductor L1 receives the direct current voltage provided by the battery at this time, to store the electrical energy from the battery 102), and when the switch circuits S2, S3 and the switch circuits S4, S5 are turned off, the switch circuit S1 is in a conducting state (the conduction control signal of the control terminal of the switch circuit S1 is at a high voltage level, the switch circuit S1 releases the electrical energy stored in the inductor L1 at this time to generate a resonant current). Similarly, the preset switching frequency of the switch circuit S1 may be, for example, the resonance frequency of the inductance-capacitance resonance circuit 104, but is not limited thereto. In addition, the switch circuits S6-S13 are kept in the off state.

By switching the conducting state of the switch circuits S1-S5 in this way, the inductance-capacitance resonance circuit 104 may generate a resonant current to heat the battery 102. Similarly, by controlling the conducting time of the switch circuits S2-S5 (that is, controlling the duty ratio of the conducting control signals of the switch circuits S2-S5) the magnitude of the resonant current may be determined, thereby determining the heating efficiency of the battery 102.

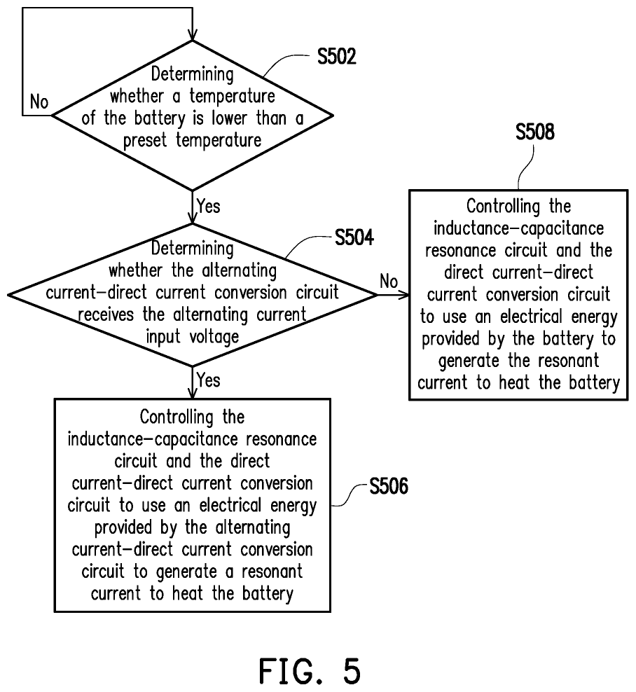

FIG. 5 is a flowchart of a temperature control method of an energy storage device according to an embodiment of the disclosure. The energy storage device includes an alternating current-direct current conversion circuit, a direct current-direct current conversion circuit, a battery, and an inductance-capacitance resonance circuit. The direct current-direct current conversion circuit is coupled to the alternating current-direct current conversion circuit and the inductance-capacitance resonance circuit. The inductance-capacitance resonance circuit is also coupled to the battery. The alternating current-direct current conversion circuit is configured to convert the alternating current input voltage received from the alternating current power source into a first direct current voltage, the direct current-direct current conversion circuit converts the first direct current voltage into a second direct current voltage. It may be known from the above embodiments that the temperature control method of the energy storage device may include the following steps. First, whether a temperature of the battery is lower than a preset temperature is determined (step S502). If the temperature of the battery is not lower than the preset temperature, the temperature of the battery is continuously detected, and whether the temperature of the battery is lower than the preset temperature is determined. If the temperature of the battery is lower than the preset temperature, then whether the alternating current-direct current conversion circuit receives the alternating current input voltage is determined (step S504). If the alternating current-direct current conversion circuit receives the alternating current input voltage, the inductance-capacitance resonance circuit and the direct current-direct current conversion circuit may then be controlled to generate a resonant current to heat the battery by using the electrical energy provided by the alternating current-direct current conversion circuit (step S506). If the alternating current-direct current conversion circuit does not receive the alternating current input voltage, the inductance-capacitance resonance circuit and the direct current-direct current conversion circuit are controlled to generate a resonant current to heat the battery by using the electrical energy provided by the battery (step S508).

To sum up, the embodiments of the disclosure control the inductance-capacitance resonance circuit and the direct current-direct current conversion circuit to use the electrical energy provided by the alternating current-direct current conversion circuit or the battery to generate a resonant current to heat the battery, so that the battery may be kept at an appropriate temperature and avoid battery damage from low temperature environment, which may improve the service life and safety of using the battery.

Although the disclosure has been described with reference to the above embodiments, they are not intended to limit the disclosure. It will be apparent to one of ordinary skill in the art that modifications to the described embodiments may be made without departing from the spirit and the scope of the disclosure. Accordingly, the scope of the disclosure will be defined by the attached claims and their equivalents and not by the above detailed descriptions.

What is claimed is:

1. An energy storage device, comprising:
an alternating current-direct current conversion circuit, configured to convert an alternating current input voltage received from an alternating current power source into a first direct current voltage;
a direct current-direct current conversion circuit, coupled to the alternating current-direct current conversion circuit, and converting the first direct current voltage into a second direct current voltage;
a battery;
an inductance-capacitance resonance circuit, coupled to the direct current-direct current conversion circuit and the battery; and
a control circuit, coupled to the alternating current-direct current conversion circuit, the direct current-direct current conversion circuit, the battery, and the inductance-capacitance resonance circuit, wherein when a temperature of the battery is lower than a preset temperature and the alternating current-direct current conversion circuit receives the alternating current input voltage, the inductance-capacitance resonance circuit and the direct current-direct current conversion circuit are controlled to use an electrical energy provided by the alternating current-direct current conversion circuit to generate a resonant current to heat the battery, when the temperature of the battery is lower than the preset temperature and the alternating current-direct current conversion circuit does not receive the alternating current input voltage, the inductance-capacitance resonance circuit and the direct current-direct current conversion circuit are controlled to use an electrical energy provided by the battery to generate the resonant current to heat the battery.

2. The energy storage device according to claim 1, wherein the inductance-capacitance resonance circuit comprises:
a first inductor, a first terminal and a second terminal of the first inductor respectively coupled to a positive electrode of the battery and the direct current-direct current conversion circuit;
a first switch circuit, coupled to the second terminal of the first inductor; and
a first capacitor, a first terminal and a second terminal of the first capacitor respectively coupled to the first switch circuit and a negative electrode of the battery, wherein when the temperature of the battery is lower than the preset temperature, the control circuit turns on the first switch circuit, so that the first inductor provides the resonant current, wherein the first inductor stores the electrical energy provided by the alternating current-direct current conversion circuit or the battery.

3. The energy storage device according to claim 2, wherein the direct current-direct current conversion circuit comprises:
a transformer, having a first side coil and a second side coil;
a second switch circuit;
a third switch circuit, wherein the third switch circuit and the second switch circuit are connected in series between the second terminal of the first inductor and the second terminal of the first capacitor;
a fourth switch circuit;
a fifth switch circuit, wherein the fifth switch circuit and the fourth switch circuit are connected in series between the second terminal of the first inductor and the second terminal of the first capacitor, a common contact of the second switch circuit and the third switch circuit is coupled to a first terminal of the first side coil, and a common contact of the fourth switch circuit and the fifth switch circuit is coupled to a second terminal of the first side coil;
a sixth switch circuit;
a seventh switch circuit, wherein the seventh switch circuit and the sixth switch circuit are connected in series between a first direct current output terminal and a second direct current output terminal of the alternating current-direct current conversion circuit;
an eighth switch circuit; and
a ninth switch circuit, wherein the ninth switch circuit and the eighth switch circuit are connected in series between the first direct current output terminal and the second direct current output terminal of the alternating current-direct current conversion circuit, a common contact of the sixth switch circuit and the seventh switch circuit is coupled to a first terminal of the second side coil, and a common contact of the eighth switch circuit and the ninth switch circuit is coupled to a second terminal of the second side coil.

4. The energy storage device according to claim 3, wherein when the temperature of the battery is lower than the preset temperature and the alternating current-direct current conversion circuit receives the alternating current input voltage, the second switch circuit to the fifth switch circuit are in an off state, the first switch circuit switches a conducting state thereof at a preset switching frequency, wherein when the first switch circuit is turned on, the sixth switch circuit to the ninth switch circuit are in the off state, and the sixth switch circuit, the ninth switch circuit, and the seventh switch circuit, the eighth switch circuit are complementarily turned on and off, to generate the resonant current to heat the battery.

5. The energy storage device according to claim 4, wherein the preset switching frequency is equal to a resonance frequency of the inductance-capacitance resonance circuit.

6. The energy storage device according to claim 4, wherein a magnitude of the resonant current is related to a duty ratio of a conduction control signal of each of the sixth switch circuit to the ninth switch circuit.

7. The energy storage device according to claim 3, wherein when the temperature of the battery is lower than the preset temperature and the alternating current-direct current conversion circuit does not receive the alternating current input voltage, the sixth switch circuit to the ninth switch circuit are in an off state, the first switch circuit switches a conducting state thereof at a preset switching frequency, wherein when the first switch circuit is turned on, the second switch circuit to the fifth switch circuit are in the off state, and the second switch circuit, the third switch circuit, and the fourth switch circuit, the fifth switch circuit are complementarily turned on and off, to generate the resonant current to heat the battery.

8. The energy storage device according to claim 7, wherein the preset switching frequency is equal to a resonance frequency of the inductance-capacitance resonance circuit.

9. The energy storage device according to claim 7, wherein a magnitude of the resonant current is related to a duty ratio of a conduction control signal of each of the second switch circuit to the fifth switch circuit.

10. A temperature control method for an energy storage device, the energy storage device comprising an alternating current-direct current conversion circuit, a direct current-direct current conversion circuit, a battery, and an inductance-capacitance resonance circuit, wherein the direct current-direct current conversion circuit is coupled to the alternating current-direct current conversion circuit and the inductance-capacitance resonance circuit, the inductance-capacitance resonance circuit is further coupled to the battery, the alternating current-direct current conversion circuit is configured to convert an alternating current input voltage received from an alternating current power source into a first direct current voltage, the direct current-direct current conversion circuit converts the first direct current voltage into a second direct current voltage, a power supplying method of the energy storage device comprising:
determining whether a temperature of the battery is lower than a preset temperature;
determining whether the alternating current-direct current conversion circuit receives the alternating current input voltage;
if the temperature of the battery is lower than the preset temperature, and the alternating current-direct current conversion circuit receives the alternating current input voltage, controlling the inductance-capacitance resonance circuit and the direct current-direct current conversion circuit to use an electrical energy provided by the alternating current-direct current conversion circuit to generate a resonant current to heat the battery; and
if the temperature of the battery is lower than the preset temperature, and the alternating current-direct current conversion circuit does not receive the alternating current input voltage, controlling the inductance-capacitance resonance circuit and the direct current-direct current conversion circuit to use an electrical energy provided by the battery to generate the resonant current to heat the battery.
